(19) United States
(12) Patent Application Publication
(10) Pub. No.: US 2007/0076131 A1
(43) Pub. Date: Apr. 5, 2007

(54) TELEVISION SET HAVING AUTOMATIC VOLUME CONTROL FUNCTION AND METHOD THEREFOR

(75) Inventors: Xiao-Guang Li, Shenzhen (CN); Kuan-Hong Hsieh, Shenzhen (CN)

Correspondence Address: NORTH AMERICA INTELLECTUAL PROPERTY CORPORATION, P.O. BOX 506, MERRIFIELD, VA, 22116, US

(73) Assignee: HON HAI PRECISION INDUSTRY CO., LTD., Taipei Hsien (TW)

(21) Appl. No.: 11/309,361

(22) Filed: Aug. 1, 2006

(30) Foreign Application Priority Data
Aug. 5, 2005 (CN) 200510036408.5

(51) Int. Cl. H04N 7/00; H04N 5/60

(52) U.S. Cl. 348/738; 348/552

(57) ABSTRACT

A television set having automatic volume control function and method therefore. The TV set includes: a communication interface for receiving an incoming call and a voltage change signal; a detecting unit for detecting the voltage change and output a corresponding volume control signal; and a volume control unit for adjusting the volume of the TV set according to the volume control signal. When the viewer receive a telephone call, a TV set connected to a telephone can lower the volume to a predetermined answering volume, when the viewer ring off the phone, the TV set can reinstate the volume of the TV set 30 to the pre-answering volume.

### TECHNICAL FIELD

The present invention relates to television (TV) sets and methods for controlling volume of the TV sets, and more specially to a TV set having automatic volume control function and a method for automatically adjusting a volume of the TV set.

### RELATED ART

Compared to the early days, a TV set can be connected to a wide range of electronic devices and gadgets. Today, the TV set brings the option of connecting to a telephone. When connected to a telephone, the TV set (if powered on) can display information of incoming calls on the TV screen, allowing a viewer to either receive or reject the incoming calls. However, when the viewer decides to answer the incoming call, the TV set does not correspondingly lower the volume of the broadcast, thus disturbing the communication of the telephone call.

Therefore, it is necessary to provide an automatic volume TV set and a method for automatically adjusting a volume of a TV set.

### SUMMARY

A television (TV) set having automatic volume control function is provided. The TV set includes: a communication interface for receiving an incoming call and a voltage change signal; a detecting unit for detecting the voltage change and output a corresponding volume control signal; and a volume control unit for adjusting the volume of the TV set according to the volume control signal. When the viewer receive a telephone call, a TV set connected to a telephone can lower the volume to a predetermined answering volume, when the viewer ring off the phone, the TV set can reinstate the volume of the TV set 30 to the pre-answering volume.

A method for adjusting volume of the TV set is provided. The method includes the steps of:

(a) receive an incoming call; (b) process and display the incoming call; (c) detecting the voltage change of a telephone line; (d) determine the level of the communication interface connected between the TV set and the telephone switched from high level to low level; (e) lower the volume of the TV set to a predetermined answering volume; (f) detect the voltage change of a telephone line; (g) determine the level of the communication interface connected between the TV set and the telephone switched from low level to high level; (h) reinstate the volume of the TV set 30 to the pre-answering volume.

The advantage of the present invention is that utilize a TV set to display an incoming call, When the viewer receive a telephone call, the TV set connected to a telephone can adjust the volume to a predetermined lower level automatically, when the viewer ring off the phone, the TV set can reinstate the volume level automatically.

### BRIEF DESCRIPTION OF DRAWINGS

FIG. 1 is a block diagram of a TV set in accordance with a preferred embodiment of the present invention; and

FIG. 2 is a flow chart of a preferred method for automatically adjusting the volume of the TV set of FIG. 1.

### DETAILED DESCRIPTION OF THE INVENTION

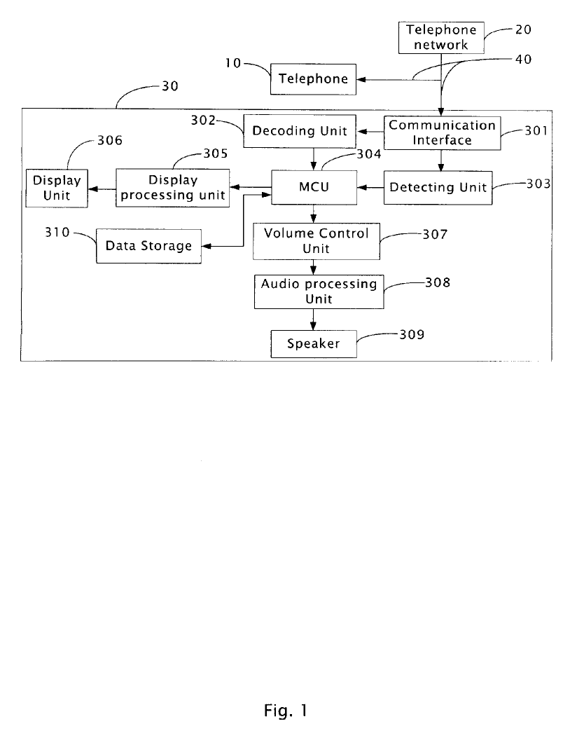

FIG. 1 is a block diagram of a television (TV) set having automatic volume control function (hereinafter “the TV set”) in accordance with a preferred embodiment of the present invention. The TV set 30 includes: a communication interface 301, a decoding unit 302, a detecting unit 303, a Micro-Controller Unit (MCU) 304, a display processing unit 305, a display unit 306, a volume control unit 307, an audio processing unit 308, at least one speaker 309, and a data storage 310.

The communication interface 301 and a telephone 10 connects with a telephone network 20 through a telephone line 40. The communication interface 301 is used to receive an incoming call from the telephone network 20 via the telephone line 40. The decoding unit 302 is connected with the communication interface 301, and is used for obtaining a caller identification (ID) of the incoming call the communication interface 301 receives. The decoding unit 302 decodes the caller ID and transmits a decoded caller ID to the display processing unit 305 through the MCU 304. The decoded caller ID is then displayed on the display unit 306 via the display processing unit 305 and prompts an incoming call.

The detecting unit 303 is used to detect voltage changes of the telephone line 40 via the communication interface 301. Generally, once an incoming call is answered with telephone 10, a voltage of the telephone line 40 drops from a high level to a low level, for example, dropping from 12 volts to 8 volts or 6 volts, or the like. When detecting such a voltage change in the telephone line 40, the detecting unit 303 outputs a volume control signal (hereinafter “control signal I”) to the volume control unit 307 through the MCU 304. The volume control unit 307 responses to the control signal I and lowers a pre-answering volume of the TV set 30 to a predetermined answering volume, for example, lowering a pre-answering volume value by fifty percent to obtain the answering volume. Thus, the speaker 309 broadcasts programs at the answering volume. Therefore, once detecting an answered incoming call, the TV set 30 automatically lowers the volume thereof to a predetermined answering volume, thus avoiding disturbing the communication the answered incoming call.

After the answered incoming call is hung up, the voltage of the telephone line 40 returns to the high level voltage before the telephone 10 is answered, for example, returning to the 12 volts. The detecting unit 303 detects the voltage change in the telephone line 40 from the low level to the high level, and accordingly outputs a volume control signal (hereinafter “control signal II”) to the volume control unit 307 through the MCU 304. The volume control unit 307 responses to the control signal II and reinstates the volume of the TV set 30 to the pre-answering volume, that is, raising the predetermined answering volume to the pre-answering volume before the incoming call is answered with the telephone 10. The speaker 309 then broadcasts programs at the pre-answering volume.

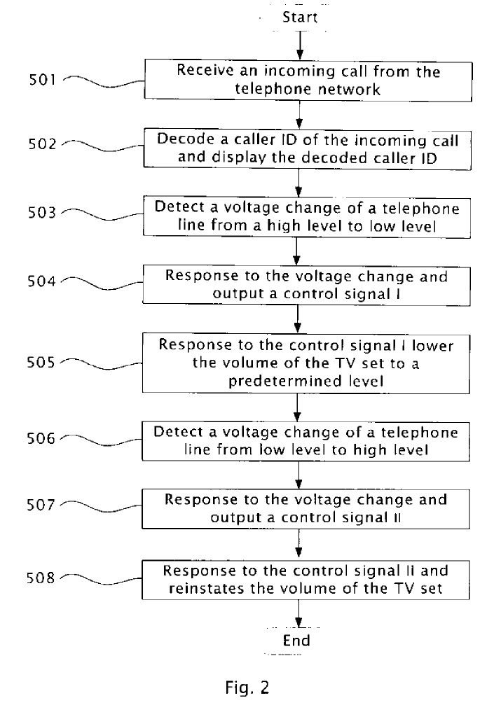

FIG. 2 is a flow chart of a preferred method for automatically adjusting a volume of the TV set 30 of FIG. 1. In step 501, the communication interface 301 receives an incoming call from the telephone network 20. In step 502, the decoding unit 302 decodes the caller ID of the incoming call and transmits the decoded caller ID to the display unit 306 to display. In step 503, a viewer picks up the telephone 10 to answer the incoming call, resulting in the voltage change of the telephone line 40 from the high level to the low level. In step 504, the detecting unit 303 detects the voltage change of the telephone line 40 and outputs the control signal I to the volume control unit 307. In step 505, the volume control unit 307 responses to the control signal I, and lowers the pre-answering volume of the TV set 30 to the predetermined answering volume. In step 506, the viewer hangs up the incoming call, resulting in the voltage change of the telephone line 40 from the low level to the high level. In step 507, the detecting unit 303 detects the voltage change of the telephone line 40 and outputs the control signal II to the volume control unit 307. In step 508, the volume control unit 307 respond to the control signal II and reinstates the pre-answering volume of the TV set 30.

Although the present invention has been specifically described on the basis of a preferred embodiment and method thereof, the invention is not to be construed as being limited thereto. Various changes or modifications may be made to the embodiments without departing from the scope and spirit of the invention.

What is claimed is:

1. A television (TV) set, comprising:
a communication interface being connected with a telephone and a telephone network via a telephone line, for receiving an incoming call from the telephone network;
a detecting unit for detecting a voltage change of the telephone line via the communication interface and outputting a volume control signal, and
a volume control unit for adjusting a volume of the TV set according to the volume control signal.

2. The TV set as claimed in claim 1, wherein the detecting unit detects the voltage change of the telephone line from a high level to a low level, and outputs a first control signal for signaling the volume control unit to lower the volume of the TV set to a predetermined level.

3. The TV set as claimed in claim 1, wherein the detecting unit detects the voltage change from a low level to a high level, and outputs a second control signal to signaling the volume control unit to raise the volume of the TV set.

4. The TV set as claimed in claim 1, wherein the TV set further comprise a decoding unit connected to the communication interface for decoding a caller identification (ID) from the communication interface and outputting a decoded caller ID to the TV set, thus displaying the caller ID.

5. A method for automatically adjusting volume of a TV set, the method comprising the steps of: determining whether a voltage level of the communication interface change or not, if the voltage level of the communication interface change, the TV set adjusts a broadcasting volume.

6. The method as claimed in claim 5, further comprising a step of receiving a user call identification (ID), processing and displaying the call ID.

7. The method as claimed in claim 5, further comprising a step of automatically lowering a broadcasting volume to a predetermined volume when the voltage level of the communication interface changes from a high level to a low level.

8. The method as claimed in claim 5, further comprising a step of automatically reinstating the broadcasting volume of the TV set when the voltage level of the communication interface change from the low level to the high level.

9. A television (TV) set, comprising:
a communication interface being connected with a telephone and a telephone network via a telephone line, for receiving an incoming call from the telephone network;
a detecting unit for detecting the voltage change of the telephone line from a high level to a low level, and outputting a first control signal, and
a volume control unit for lowering the volume of the TV set to a predetermined level upon receiving the first control signal.
